(19) United States
(12) Patent Application Publication
(10) Pub. No.: US 2016/0299529 A1
(43) Pub. Date: Oct. 13, 2016

(54) PACKAGE FOR MOBILE ELECTRONIC DEVICES AND A KIT CONTAINING REMOVABLE ELEMENTS FOR MOBILE ELECTRONIC DEVICES

(71) Applicants: Yariv ERAD, Kidron (IL); Menachem ERAD, Ashdod (IL)

(72) Inventors: Yariv ERAD, Kidron (IL); Menachem ERAD, Ashdod (IL)

(21) Appl. No.: 15/037,752

(22) PCT Filed: Nov. 19, 2014
(86) PCT No.: PCT/IL14/51006

§ 371 Date: May 19, 2016

Related U.S. Application Data
(60) Provisional application No. 61/906,525, filed on Nov. 20, 2013.
(60) Provisional application No. 61/906,538, filed on Nov. 20, 2013.

(51) Int. Cl. G06F 1/16; G08B 5/36; G08B 13/24; G06F 11/32

(52) U.S. Cl. CPC G06F 1/1632; G06F 11/32; G08B 5/36; G08B 13/2402

(57) ABSTRACT

The present invention discloses a package for a mobile electronic device, comprising a housing; one or more compartments located inside the housing configured to store one or more physical components interacting with the mobile electronic device, the one or more physical components are inserted to the housing via one or more apertures on the housing. In some cases, the mobile electronic device is stored in one of the compartments. In some cases, the package further comprises a display device positioned on an exterior of the housing.

### FIELD OF THE INVENTION

The invention generally relates to a package for storing removable elements for mobile electronic devices.

### BACKGROUND OF THE INVENTION

There is a growing demand for mobile electronic devices, such as smartphone, smartwatch, tablets, phablets, laptops, ultra-light laptops, digital cameras, etc. The hi-tech industry have managed to develop an ecosystem of accessories and add-on hardware components for those devices. For example, the iOS devices line by Apple has generated the creation of various accessories that interact, communicate with or can be physically attached to the mobile devices, such as microphones, camera lenses, medical sensors, batteries power-packs, projectors, and others.

A user of such a mobile electronic device who owns accessories and wishes to use them frequently for the mobile electronic device might find himself carrying several cases—one case for the device itself and another case for each of the accessories he purchased for the device. In addition, there are mobile device manufacturers who develop modular devices. Such modular devices will enable the user to replace existing modules in the device with other modules, or to attach additional modules to the device. For example, a user may select to change the type of screen he is using from a screen type that is aimed to support rich-graphics gaming SW applications, to e-ink screen type that supports text reading.

In the field of consumer electronics, the common practice of using the package of a newly purchased accessory is first open the package and retrieve the content, then discard of the package, store it somewhere, or recycle it. The package is not considered part of the product, and in most cases has no functional tasks other than to protect the product before the product is purchased and used. In addition, the device manufacturers always aspire to reduce the logistics costs associated with packaging and transportation of the device, and to reduce the costs associated with storage. For that reason, the device manufacturers improve the packaging to reduce package size or make it lighter.

### SUMMARY OF THE INVENTION

It is an object of the present invention to discloses a package for a mobile electronic device, comprising a housing and one or more compartments located inside the housing configured to store one or more physical components interacting with the mobile electronic device, the one or more physical components are inserted to the housing via one or more apertures on the housing.

In some cases, the mobile electronic device is stored in one of the one or more compartments.

In some cases, the package further comprises a display device positioned on an exterior of the housing.

In some cases, the display device displays indications concerning the one or more physical components.

In some cases, the display device displays indications concerning the one or more physical components.

In some cases, the package further comprises an input unit on the display device for enabling a user of the package to input information.

In some cases, the information inputted into the input unit concerns the package or the one or more physical components. In some cases, the information inputted into the input unit is transmitted to the mobile electronic device via a communication module located inside the housing. In some cases, the information transmitted to the mobile electronic device is used to configure the mobile electronic device. In some cases, the information transmitted to the mobile electronic device is used to control a computerized application installed on the mobile electronic device.

In some cases, a computerized application activates an alarm on the computerized application according to information inputted to the input unit of the package.

In some cases, at least two of the one or more physical components are of different shapes or different sizes.

In some cases, the package further comprises a communication module for communicating with the mobile electronic device.

In some cases, the communication module receives a command from the mobile electronic device via a wireless signal. In some cases, the command activates an alert in the package via a signal sent from the mobile electronic device.

In some cases, the communication unit receives a command concerning the mobile electronic device from a remote device while the mobile electronic device is located inside the housing.

In some cases, the communication unit receives a command to change display configuration of the mobile electronic device at a point of sale.

In some cases, the package further comprises an indication unit associated with at least one of the one or more compartments for representing information concerning a compartment of the one or more compartments.

In some cases, the indication unit provides a visual indication or an illumination indication.

In some cases, the package further comprises an indication unit associated with at least one of the one or more physical components for representing information concerning a physical components of the one or more physical components.

In some cases, the package further comprises a transparent or semi-transparent display device, such that a user of the package can see the indication concerning the physical component while using the display device.

In some cases, at least a portion of the housing is transparent.

In some cases, the housing is connected to a power outlet and the package is configured to connect at least one of the one or more physical components to an external power source.

In some cases, the package further comprises a speaker unit.

In some cases, at least one of the one or more physical components is a sensor for sensing information concerning the mobile electronic device.

In some cases, at least one of the one or more physical components is a display device, to enable at least two display configurations for the mobile electronic device.

In some cases, the package further comprises a storage unit synchronized to a memory of the mobile electronic device.

In some cases, the package further comprises a storage unit synchronized to a memory of one of the one or more physical components.

In some cases, at least one of the one or more compartments is removable from the housing.

In some cases, at least a portion of the housing is made of flexible materials.

In some cases, one of the one or more physical components is slidable or foldable on another physical component of the one or more physical components.

In some cases, the package further comprises a security unit associated with a compartment of the housing.

In some cases, the security unit is configured to lock the mobile electronic device inside the package unless a person complies with a rule of the security unit.

In some cases, the security unit is configured to send a message to a remote electronic device in case the mobile electronic device is removed from the housing without complying with a rule of the security unit.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a housing of a package and physical components inserted into the housing, in accordance with a preferred embodiment of the invention;

FIG. 2 shows a mobile electronic device inside a housing of a package, in accordance with a preferred embodiment of the invention;

FIG. 3 shows an input unit on a housing of a package and physical components inserted into the housing, in accordance with a preferred embodiment of the invention;

FIG. 4 shows a block diagram of a package for storing physical components that interact with a mobile electronic device, in accordance with a preferred embodiment of the invention;

FIG. 5 shows a mobile electronic device with a replaceable display device, in accordance with a preferred embodiment of the invention.

### DETAILED DESCRIPTION OF THE INVENTION

The present invention discloses a package for storing physical components that interact with a mobile electronic device, such as a smartphone, smartwatch, tablet and the like. The package comprises a housing with compartments for storing the physical components, such as display devices, charger, sensors, lenses and the like. At least some of the physical components may be non-electronic components, such as a wrist band for carrying the mobile electronic device stored in a compartment in the housing. The housing may also be equipped with electronic circuitry for enhancing the functionality of the package and the physical components as will be detailed below.

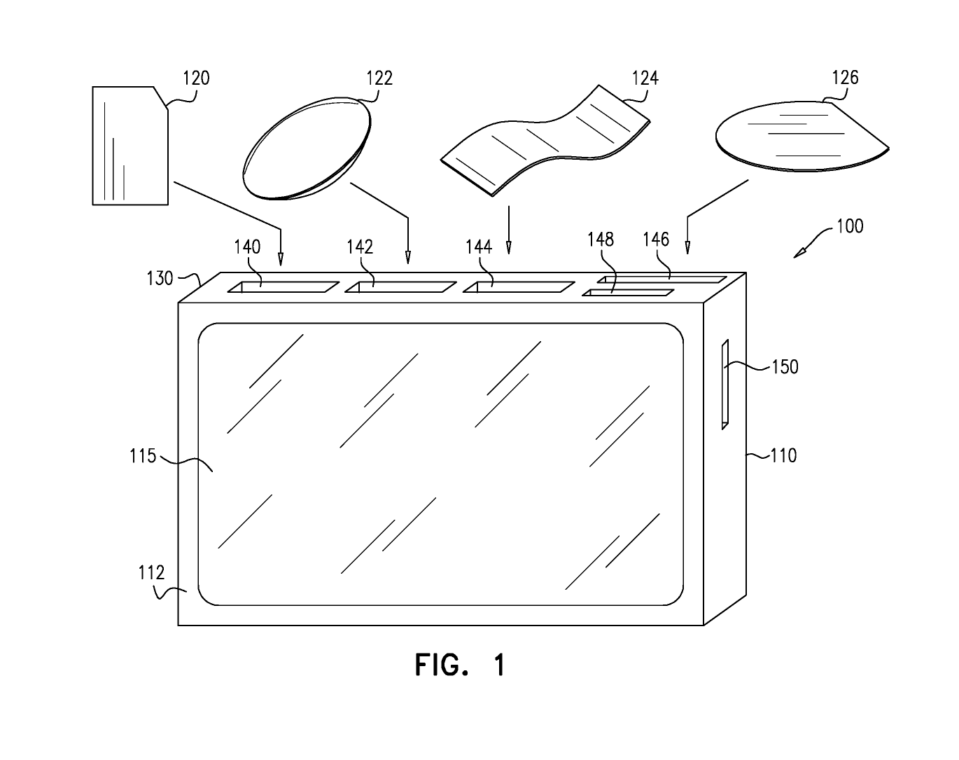

FIG. 1 shows a housing of a package and physical components inserted into the housing, in accordance with a preferred embodiment of the invention. The package 100 comprises an electronic circuitry 150 located in a lateral portion of the housing 110. The electronic circuitry 150 may be connected to a processor and transmit commands and signals from the processor to additional components located inside the housing 110. The package 100 may also comprise a display device 115 located on a front side 112 of the housing 110. The display device 115 may act as an input unit of the package 100, enabling a user of the package to input data into the physical components of the package 100, or into the electronic circuitry 150, such as change of settings of the functional units of the package 100, such as communication unit, indication unit, security unit and the like. The display device 115 may be transparent or semi-transparent in order to enable the user of the package to view components inside the housing 110. The display device 115 may be used to view information displayed on the mobile electronic device associated with the package 100 via the communication unit, or view a command or message sent between the mobile electronic device and the communication unit of the package 100.

The package 100 comprises one or more compartments for storing the physical components that interact with the mobile electronic device. The meaning of interact may be a component that can be attached to the mobile electronic device, may communicate with the mobile electronic device such as a sensor, or a non-electronic component.

The housing 110 contains one or more compartments 140, 142, 144, 146, 148 for storing physical components 120, 122, 124, 126 that interact with the mobile electronic device. Such physical components may be display devices 120, 126 of various shapes, properties or sizes, a display device made of elastic materials 124, a lens 122 and additional optional physical components such as wearable elements, glasses, wrist bands, remote control, gaming equipment and the like. The one or more compartments 140, 142, 144, 146, 148 may be located on the upper side 130 of the housing 110. In some exemplary cases, at least some of the one or more compartments 140, 142, 144, 146, 148 are removable from the housing 110 in order to enable insertion of various physical components into the package 100. For example, a user of the package 100 may remove compartments 140 and 142 and insert a single and bigger compartment into the housing 110 in order to store a larger component in the package 100.

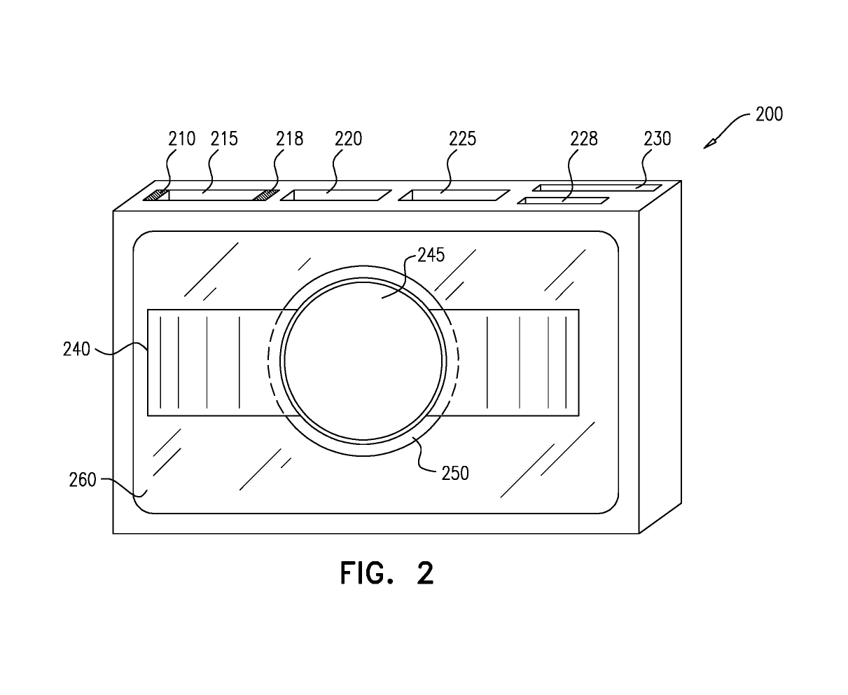

FIG. 2 shows a mobile electronic device inside a housing of a package, in accordance with a preferred embodiment of the invention. The package 200 comprises a plurality of compartments 215, 220, 225, 228 and 230, for storing physical components that are relevant for the functionality of a mobile electronic device 240 contained in the housing 260 of the package 200. At least some of the plurality of compartments 215, 220, 225, 228 and 230 provide an indication associated with the compartment or with the physical component stored in the compartment. For example, an indication may be light displayed on light emitters 210, 218 which provide an indication on a status of compartment 215. The indication may be represented by a specific color emitted by the light emitters 210, 218, or via audio emitted from a speaker (not shown) located inside the package 200. The indication may be provided with regard to power status of the physical component, the information transferred to the physical component from an external module, the type of application activated on the physical component or on the display device of the package 200, malfunction on the package 200, and the mobile electronic device or on the physical component. In some cases at least a portion of the housing or the display device are transparent or semi transparent and the indication unit is located in the inner portion of the compartment.

In some exemplary cases, the mobile electronic device 240 is contained inside the package 200, for example before the mobile electronic device 240 is purchased in a retail store, and also when the user of the mobile electronic device 240 wishes to carry it elsewhere. The electronic circuitry 245 of the mobile electronic device 240 may be placed on a seating 250 inside the package 200. The seating 250 may be electronically coupled to a communication module of the package 200. The communication module of the package 200 may receive a signal from a remote device and send the signal to the mobile electronic device 240 while the mobile electronic device 240 is stored inside the package 200. Such command may be to activate an application on the mobile electronic device 240 or display predefined information on the mobile electronic device 240.

In some exemplary cases, at least one of the compartments is connected to a security unit. The security unit may prevent removal or insertion of the physical component associated with the compartment in case the user fails to comply with a predefined rule of the security unit. Such rule may be a password, or according a biometric test, for example by comparing the user's predefined fingerprint or eyeball to the fingerprint detected by a camera or a sensor of the package 200 when removing the physical component. In some exemplary cases, the security unit is not capable of preventing the insertion or removal of the physical component and will issue a message to a remote location, such as the mobile electronic device 240, that the physical component was inserted to or removed from the package without complying with a rule of the security unit.

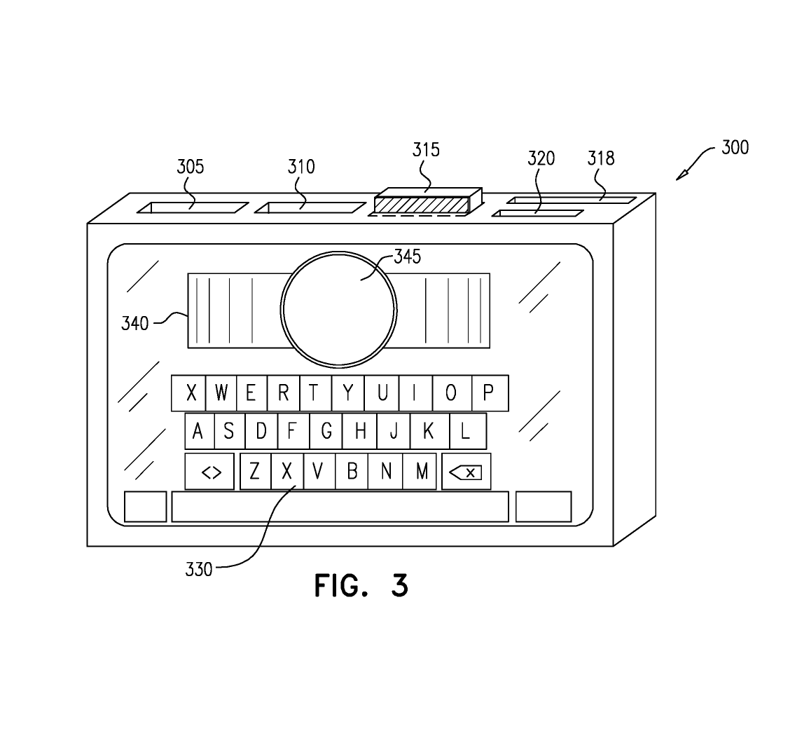

FIG. 3 shows an input unit on a housing of a package and physical components inserted into the housing, in accordance with a preferred embodiment of the invention. The input unit 330 may be implemented as a touch screen and enable a user of the package 300 to input information or commands by touching the side of the package 300 only. In some other cases, the input unit 330 may be activated or deactivated by a button or a command from the user of the package 300. The command or information inputted to the input unit may be used to change properties of units inside the package 300, for example the indication unit or the communication unit discussed above. In some other cases, the commands from the user may be transmitted via the communication unit to another device, for example to the mobile electronic device 345 associated with the package 300. In some exemplary cases, the mobile electronic device 345 may be associated with a wrist band 340 also contained inside the package 300. In some exemplary embodiments of the disclosed subject matter, the display device of the mobile electronic device 345 may be removable, for example to change the size of the display device, or change a property of the display device to fit to the user's desired functionality.

The package 300 may contain a plurality of compartments 305, 310, 315, 320 and 318. In some exemplary cases, at least one of the compartments is electronically coupled to the electronic circuitry of the package 300. For example, the compartment 315 is equipped with a charging unit for charging the physical component inserted thereto. The charging unit may receive power from an internal power unit of the package, such as a battery. The charging unit may receive power from an external source, such as an electrical socket, to which the package 300 is connected.

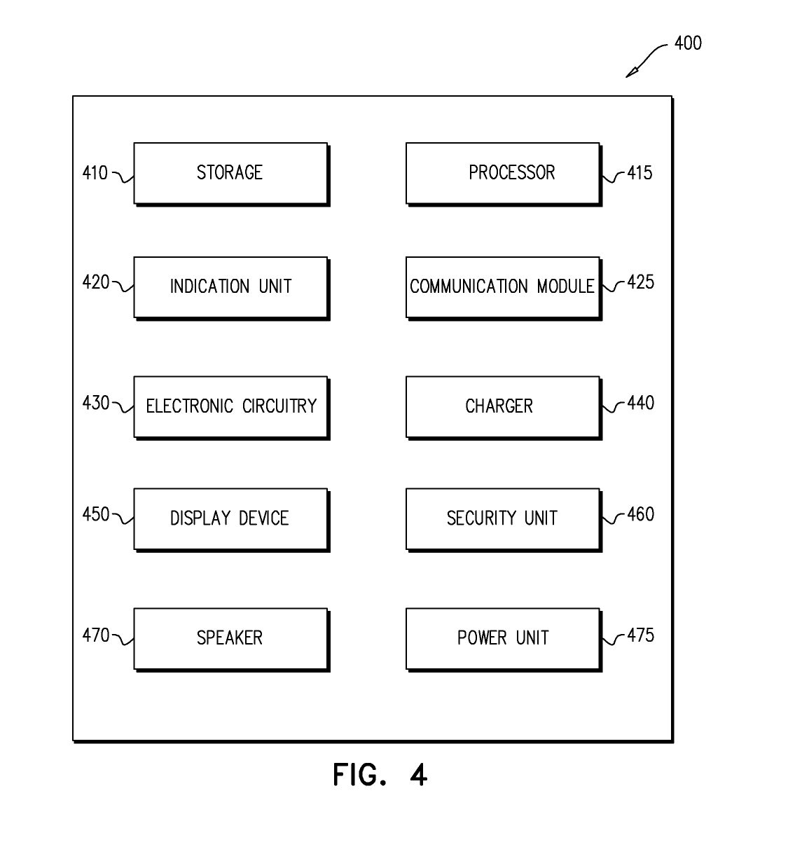

FIG. 4 shows a block diagram of a package for storing physical components that interact with a mobile electronic device, in accordance with a preferred embodiment of the invention. The package 400 comprises a processor 415 for controlling various computerized units inside the package 400, for example by issuing commands or signals to those computerized units. For example, the package 400 comprises a storage 410 for storing a set of rules according to which some elements of the package 400 operate. The display device 450 of the package 400 may display information from a remote device according to the set of rules stored in the storage 410 responsive to commands or signals sent from the processor 415. The storage 410 may be used to back-up memory of another electronic device, such as the mobile electronic device with which physical components of the package interact.

The package 400 may also comprise an indication unit 420 for issuing indications concerning a compartment of the package 400 or about a physical component stored in the package 400. In some cases, the indication may be about insertion or removal of a physical component from a compartment of the package 400. The indication may be provided via illumination, color of light, an audio signal emitted via a speaker 470 and the like. The visual indication may be shown in the relevant compartment, in a control panel of the package 400 or on the display device 450. The indication unit may be connected to a security unit 460 to provide an indication in case the use of a compartment or an item in the package 400 fails to comply with a security policy implemented by the security unit 460. Such security policy may require a person to input an ID number when removing a physical component from the package 400 or when inserting such component into a compartment. The security policy may request the person to take an image of his face or finger print in order to perform any action on the package 400, for example write a message on an input unit of the display device 450 to be sent to another electronic device. The security unit 460 may issue an alert message to be sent to another item in case the security policy is not met, via a communication module 425.

The communication module 425 enables various elements in the package 400 to communicate with external entities, such as the user's mobile electronic device, the user's email address, an external server or a remote control in a retail store. The communication module 425 transfers signals to the processor 415 which translates the signals into commands sent to units of the package 400. For example, the remote control of the seller in the retail store may send the communication module 425 a command to activate the mobile electronic device when stored in seating inside the package 400. The processor then sends a signal to the seating to activate the mobile electronic device, as the seating is electronically coupled to the mobile electronic device.

The package 400 may also comprise a charger 440 for charging a battery of one or more physical components stored in compartments. The charger 440 may be electronically coupled to the relevant physical components and receive indications concerning the power level of the physical components from the indication unit 420. The charger 440 may be connected to an internal power unit 475 of the package 400 or be connected to an external power source, such as a power socket.

The package 400 also comprises electronic circuitry 430 for connecting the modules discussed above in a wired manner. For example, the electronic circuitry 430 may be connected to the communication module 425 and to the display device 450, such that a message received wirelessly at the communication module 425 is sent via the electronic circuitry 430 to be displayed at the display device 450. In some exemplary cases, the information displayed on the display device 450 of the package 400 effects the information displayed on a remote device, such as the mobile electronic device.

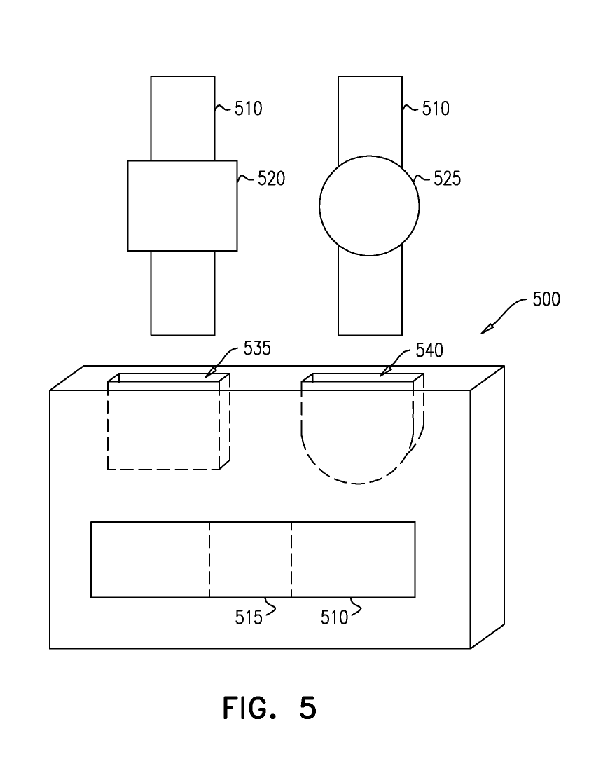

FIG. 5 shows a mobile electronic device with a replaceable display device, in accordance with a preferred embodiment of the invention. The mobile electronic device may be a smartphone, a smartwatch or any other mobile electronic device desired by a person skilled in the art. The smartwatch may be equipped with a wrist band 510 to be wrapped around the user's arm. The wrist band 510 comprises a connector 515 which enables removal and attachment of display devices. The connector 515 may enable mechanic fixation of the display device to the wrist band 510 or electronic, to enable passage of signals from the wrist band 510 to the display device. The connector enables the user of the smartwatch to replace a first display device 525 with a second display device 520 when desired. A rectangular display device 520 may be preferred by the user for some activities and the circular display device 525 may be preferred by the user for other activities. The package 500 may store the rectangular display device 520 in a first compartment 535, store the circular display device 525 in a second compartment 540 and store the wrist band 510 on an exterior of the package 500.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A package for a mobile electronic device, comprising:
a housing;
one or more compartments located inside the housing configured to store one or more physical components interacting with the mobile electronic device, the one or more physical components are inserted to the housing via one or more apertures on the housing.

2. The package of claim 1, wherein the mobile electronic device is stored in one of the one or more compartments.

3. The package of claim 1, further comprises a display device positioned on an exterior of the housing.

4. The package of claim 3, wherein the display device displays indications concerning the one or more physical components.

5. The package of claim 3, wherein the display device displays indications concerning the one or more physical components.

6. The package of claim 3, further comprises an input unit on the display device for enabling a user of the package to input information.

7. The package of claim 6, wherein the information inputted into the input unit concerns the package or the one or more physical components.

8. The package of claim 6, wherein the information inputted into the input unit is transmitted to the mobile electronic device via a communication module located inside the housing.

9. The package of claim 8, wherein the information transmitted to the mobile electronic device is used to configure the mobile electronic device.

10. The package of claim 8, wherein the information transmitted to the mobile electronic device is used to control a computerized application installed on the mobile electronic device.

11. The package of claim 10, wherein a computerized application activates an alarm on the computerized application according to information inputted to the input unit of the package.

12. The package of claim 1, wherein at least two of the one or more physical components are of different shapes or different sizes.

13. The package of claim 1, further comprises a communication module for communicating with the mobile electronic device.

14. The package of claim 13, wherein the communication module receives a command from the mobile electronic device via a wireless signal.

15. The package of claim 14, wherein the command activates an alert in the package via a signal sent from the mobile electronic device.

16. The package of claim 13, wherein the communication unit receives a command concerning the mobile electronic device from a remote device while the mobile electronic device is located inside the housing.

17. The package of claim 13, wherein the communication unit receives a command to change display configuration of the mobile electronic device at a point of sale.

18. The package of claim 1, further comprises an indication unit associated with at least one of the one or more compartments for representing information concerning a compartment of the one or more compartments.

19. The package of claim 18, wherein the indication unit provides a visual indication or an illumination indication.

20. The package of claim 1, further comprises an indication unit associated with at least one of the one or more physical components for representing information concerning a physical components of the one or more physical components.

21. The package of claim 1, further comprises a transparent or semi-transparent display device.

22. The package of claim 1, wherein the housing is connected to a power outlet and the package is configured to connect at least one of the one or more physical components to an external power source.

23. The package of claim 1, further comprises a speaker unit.

24. The package of claim 1, wherein at least one of the one or more physical components is a sensor for sensing information concerning the mobile electronic device.

25. The package of claim 1, wherein at least one of the one or more physical components is a display device, to enable at least two display configurations for the mobile electronic device.

26. The package of claim 1, further comprises a storage unit synchronized to a memory of the mobile electronic device.

27. The package of claim 1, further comprises a storage unit synchronized to a memory of one of the one or more physical components.

28. The package of claim 1, wherein at least one of the one or more compartments is removable from the housing.

29. The package of claim 1, wherein at least a portion of the housing is made of flexible materials.

30. The package of claim 1, wherein one of the one or more physical components is slidable or foldable on another physical component of the one or more physical components.

31. The package of claim 1, further comprises a security unit associated with a compartment of the housing.

32. The package of claim 31, wherein the security unit is configured to lock the mobile electronic device inside the package unless a person complies with a rule of the security unit.

33. The package of claim 31, wherein the security unit is configured to send a message to a remote electronic device in case the mobile electronic device is removed from the housing without complying with a rule of the security unit.
